(19) United States
(12) Patent Application Publication
(10) Pub. No.: US 2007/0197227 A1
(43) Pub. Date: Aug. 23, 2007

(54) System and method for enabling combinational services in wireless networks by using a service delivery platform

(75) Inventors: Shamim A. Naqvi, Boston, MA (US); Aashu Virmani, North Andover, MA (US); Prasad S. Dorbala, Lexington, MA (US)

Correspondence Address: WILMER CUTLER PICKERING HALE AND DORR LLP, 60 STATE STREET, BOSTON, MA, 02109, US

(73) Assignee: Aylus Networks, Inc.

(21) Appl. No.: 11/504,896

(22) Filed: Aug. 16, 2006

Related U.S. Application Data
(60) Provisional application No. 60/776,137, filed on Feb. 23, 2006.
(60) Provisional application No. 60/779,954, filed on Mar. 7, 2006.
(60) Provisional application No. 60/800,688, filed on May 16, 2006.
(60) Provisional application No. 60/809,029, filed on May 26, 2006.

(51) Int. Cl. H04Q 7/20

(52) U.S. Cl. 455/445

(57) ABSTRACT

Under one aspect, a method of providing combinational services to a user endpoint includes providing a radio access network in communication with the user endpoint; providing a circuit-switched (CS) network in communication with the radio access network, the CS network comprising at least one mobile switching center (MSC) capable of providing a voice service to the user endpoint via the radio access network; providing an IP multimedia subsystem (IMS) core in communication with the radio access network, the IMS core comprising at least one call state control function (CSCF); providing one or more application servers (AS) in communication with the IMS core, the one or more AS capable of providing a corresponding one or more data services to the user endpoint via the CSCF and radio access network; providing a serving node (SN) in communication with the CS network and the IMS core; configuring logic in the MSC to send a first pre-defined message to the SN in response to a trigger detection point (TDP) that is triggered by the user endpoint requesting a voice service or a first entity requesting a voice service with the user endpoint; configuring logic in the CSCF to send a second pre-defined message to the SN in response to a service point trigger (SPT) that is triggered by the user endpoint requesting a data service or by a second entity requesting a data service with the user endpoint; and configuring logic in the SN to receive and respond to at least one of the first and second pre-defined messages by at least one of sending instructions to the MSC to provide a voice service to the user endpoint and sending instructions to the AS to provide a data service to the user endpoint.

### CROSS-REFERENCE TO RELATED APPLICATIONS

This application claims the benefit under 35 U.S.C. § 119(e) of the following applications, the entire contents of which are incorporated herein by reference:

U.S. Provisional Patent Application No. 60/776,137, filed Feb. 23, 2006, entitled Enabling Combinational Services in Networks that Do Not Support Multiple Radio Access Bearers;

U.S. Provisional Patent Application No. 60/779,954, filed Mar. 7, 2006, entitled Using Telephony Interface for Invoking Data Services In Wireless Communication Networks;

U.S. Provisional Patent Application No. 60/800,688, filed May 16, 2006, entitled System and Method for Supporting Combinational Services Without Simultaneous Packet and Circuit Connections; and

U.S. Provisional Patent Application No. 60/809,029, filed May 26, 2006, entitled System and Method for Supporting Combinational Services Without Simultaneous Packet and Circuit Connections.

### BACKGROUND

1. Field of the Invention

The invention generally relates to wireless networks and to IP multimedia subsystem (IMS) networks.

2. Description of Related Art

New types of services for wireless networks, called combinational services, have been the subject of recent proposals in 3GPP and other standardization bodies. The proposed combinational services typically involve a voice call that is simultaneously juxtaposed with the transmission of a multimedia object (i.e., a video file or live streaming from a camcorder integrated in the handset) from one participant to another in the ongoing voice call. One example of a combinational service would be a voice call between two subscribers that is augmented by transmitting a multimedia object from the caller to the called party. In this example, the caller could use a video camera in his handset to show the called party an object in close proximity, e.g., an automobile or a house, and simultaneously converse with the called party. Other examples of possible combinational services include white-board discussions, collaborative multi-party games, and external camera feeds. A feature common to these examples is augmenting a voice conversation by adding a multimedia feed to the same session. Some wireless service providers have begun to demonstrate early versions of such services.

The prevailing state of the art proposes that the voice call in a combinational service be carried by a circuit-switched wireless network, such as the Public Land Mobile Network (PLMN), and that the multimedia session be carried by a packet-switched wireless network, such as the IP Multimedia Subsystem (IMS). Thus, the proposals envision two separate but simultaneous connections between the mobile handsets participating in the combinational service.

The circuit-switched PLMN and packet-switched IMS networks will now be described in greater detail.

In a circuit-switched network such as PLMN, users' network mobile handsets are connected to Base Transceiver Stations (BTS) through a radio access network. The BTS in turn are connected to a plurality of Base Station Servers (BSC) that in turn are connected to a network of Mobile Switching Centers (MSC). The MSC provide wireless services to the users' handsets, and are also inter-connected with the Public Switched Telephone network (PSTN). This arrangement makes it possible for voice traffic to be carried between mobile handsets and landline telephone sets. The MSC in a wireless network effectively behaves as a switch that supports the mobility and roaming functions of a user's handset.

When a user's handset requests a telephone call or a service, such as voice mail, a prepaid call, or a toll-free call, it generates a “call event” at the MSC. Each call event can potentially “trigger” one or more Trigger Detection Points (TDP) in the MSC. When a call event triggers a particular TDP, the MSC sends a pre-specified message to a Service Control Function (SCF). The message includes, for example, the phone numbers of the calling and called parties, and the nature of the service request. The SCF then “fields” the message, i.e., service logic within the SCF responds appropriately to the message. In WIN/CAMEL implementations, the MSC and SCF communicate using standards-based protocols such as Transaction Capabilities Application Part (TCAP) from the family of protocols commonly referred to as Signaling System 7 (SS7).

For example, consider a “call origination” call event that happens when a user makes a new call request at the MSC. This call event triggers a corresponding TDP, causing the MSC to send a message with event-related information to the SCF, e.g., the calling and called numbers. The SCF then processes the message, e.g., by querying an internal or external database to verify that the calling party is authorized to initiate telephone calls. The SCF then responds back to the MSC with a message that indicates whether the call is “allowed” or “denied.”

In the packet-switched network, services are generally supported by IP Multimedia Subsystem (IMS). The IMS architecture manages the network with several control functions, i.e., functional entities. The Breakout Gateway Control Function (BGCF) is an inter-working function that handles legacy circuit-switched traffic. A new function called the Media Gateway Control Function (MGCF) controls the Media Gateway (MGW). The Media Resource Function Processor (MRFP), which is controlled by the Media Resource Control Function (MRFC), performs media processing functions. An IMS session is controlled by a logical function called the Call State Control Function (CSCF). It is logically partitioned into three functional entities, the Proxy, Interrogating and Serving CSCFs. The Proxy Call State Control Function (P-CSCF) is the first contact point for a user's handset, also referred to herein as the User Entity (UE). The Interrogating CSCF (I-CSCF) is mainly the contact point within an operator's network for all IMS connections destined to a subscriber of that network operator, or a roaming subscriber currently located within that network operator's service area. The Serving CSCF (S-CSCF) actually handles the session states in the network. “Third party” application servers (AS) provide services to the UE, such as voice mail, via the S-CSCF. The IMS controls packet services among the different functional entities with signaling protocols such as Session Initiation Protocol (SIP), which is an IP-based signaling protocol designed for multimedia communications.

When a UE first powers on, logic residing in the UE initiates a “registration” procedure with the IMS core, first by requesting the radio access network to assign it an IP address. After it receives an IP address, the UE attempts to register as an IP-enabled endpoint with the IMS core, by sending a “register” request to the P-CSCF. Assuming that the UE is registering from a visiting domain, the P-CSCF then uses a Domain Name Server (DNS) to search for the UE's home domain S-CSCF. Once the P-CSCF locates the S-CSCF for the UE, it passes the “register” request to that S-CSCF. The S-CSCF contacts the Home Subscriber Subsystem (HSS), which looks up the UE's profile. This profile contains assorted information about the user, and what services the UE is authorized to use. A logical function in the S-CSCF called the “registrar” then authenticates the UE, e.g., verifies that the UE is legitimate.

The S-CSCF also loads Service Point Triggers (SPT) from the UE's profile. The SPT define the appropriate action for the S-CSCF to take when the UE or AS requests a transaction. For example, if the UE requests voice mail service, the SPT triggers the S-CSCF to provide the addresses of the voice mail AS for the UE. So long as the UE is powered on, the SPT for that UE are loaded into the S-CSCF, so a service request fires the appropriate trigger in the S-CSCF. The SPT are analogous to the above-described TDP in the CS network. The SPT and TDP both trigger an appropriate response from a controlling server, e.g., the MSC or S-CSCF. However, the TDP are more generally applicable to call requests and call related events such as dialed number, etc., and are not particular to the user's profile. The SPT are specific to the UE, and are stored in the user's profile in the HSS and loaded into the S-CSCF when the UE registers.

If an entity wishes to engage in a transaction with the UE, e.g., to send a message to the UE, the entity utilizes an AS to send a request for the transaction to the S-CSCF. This triggers an SPT in the S-CSCF, which recognizes the request as pertaining to a registered UE and sends the appropriate information to the handset. Other ASs may not know which S-CSCF to contact in order to engage in a transaction with a particular UE. In this case, the AS interrogate a Subscriber Location Function (SLF), which provides information about a UE's S-CSCF to the AS, which then contacts that S-CSCF as described above. If the UE wishes to request a service, it sends the request to the S-CSCF, e.g., using a SIP invite. This triggers an SPT in the S-CSCF, which then directs the service request to a particular Application Server (AS), which then provides the service to the UE. For example, if the user wants to initiate an IMS call, it sends a SIP invite message to the S-CSCF, which may then contact the AS responsible for IMS calls, called the Back-to-Back User Agent (B2BUA), which initiates the IMS call flow.

As noted above, prior proposals for combinational services require user's handsets to separately use the circuit-switched PLMN network for voice services and the packet-switched IMS network for data services. However, to provide combinational services in this way, it would be necessary for the radio access network to be capable of establishing and simultaneously maintaining connections to a user's handset over both the circuit-switched PLMN voice network and the packet-switched IMS data network. In other words, the radio access network would have to be capable of supporting two or more Radio Access Bearers (RAB). However, the current “2G” network cannot simultaneously support two RABs. Thus, the combinational service proposals generally require deploying new “3G” networks. For example, proposals for GSM networks deploy UMTS Terrestrial Radio Access Network (UTRAN) radio technology; proposals made for Edge/GPRS networks deploy Dual Transmission Mode (DTM) technology, which uses two distinct frequencies for the two kinds of network connections; and proposals made for CDMA deploy Wideband CDMA (WCDMA).

However, deploying “3G” networks is a costly undertaking.

### SUMMARY

The present invention provides systems and methods for enabling combinational services in wireless networks by using a service delivery platform.

Under one aspect, a method of providing combinational services to a user endpoint includes providing a radio access network in communication with the user endpoint; providing a circuit-switched (CS) network in communication with the radio access network, the CS network comprising at least one mobile switching center (MSC) capable of providing a voice service to the user endpoint via the radio access network; providing an IP multimedia subsystem (IMS) core in communication with the radio access network, the IMS core comprising at least one call state control function (CSCF); providing one or more application servers (AS) in communication with the IMS core, the one or more AS capable of providing a corresponding one or more data services to the user endpoint via the CSCF and radio access network; providing a serving node (SN) in communication with the CS network and the IMS core; configuring logic in the MSC to send a first pre-defined message to the SN in response to a trigger detection point (TDP) that is triggered by the user endpoint requesting a voice service or a first entity requesting a voice service with the user endpoint; configuring logic in the CSCF to send a second pre-defined message to the SN in response to a service point trigger (SPT) that is triggered by the user endpoint requesting a data service or by a second entity requesting a data service with the user endpoint; and configuring logic in the SN to receive and respond to at least one of the first and second pre-defined messages by at least one of sending instructions to the MSC to provide a voice service to the user endpoint and sending instructions to the AS to provide a data service to the user endpoint.

One or more embodiments include one or more of the following features. The radio access network provides a connection between the user endpoint and only one of the CS network and IMS core at a given time. Registering the user endpoint to the IMS core. Registering the user endpoint to the IMS core includes obtaining at the CSCF information about the profile of the user endpoint. The profile of the user endpoint includes the SPT. The SN determines whether the combinational service is authorized before responding to at least one of the first and second pre-specified messages. The first pre-defined message includes a telephone number of the user endpoint and the nature of the voice service request. The second pre-defined message includes an IP address of the user endpoint and the nature of the data service request.

Under another aspect, a system for providing combinational services to a user endpoint includes a radio access network in communication with the user endpoint; a circuit switched (CS) network in communication with the radio access network, the CS network comprising at least one mobile switching center (MSC) capable of providing a voice service to the user endpoint via the radio access network; an IP multimedia subsystem (IMS) core in communication with the radio access network, the IMS core comprising at least one call state control function (CSCF); an application server (AS) in communication with the IMS core, the AS capable of providing a data service to the user endpoint via the IMS core and the radio access network; a serving node (SN) in communication with the CS network and the IMS core, wherein the at least one MSC includes logic configured to provide a first pre-determined message to the SN in response to a trigger detection point (TDP) that is triggered by voice service request by the user endpoint or by a first entity attempting to initiate a voice service with the user endpoint; wherein the at least one CSCF includes logic configured to provide a second pre-determined message to the SN in response to a service point trigger (SPT) that is triggered by a data service request by the user endpoint or by a second entity attempting to initiate a data service with the user endpoint; and wherein the SN includes logic configured to initiate a combinational service in response to receiving at least one of the first and second pre-determined messages, wherein initiating a combinational service includes at least one of providing instructions to the MSC to initiate a voice service to the user endpoint and providing instructions to the AS to initiate a data service to the user endpoint.

One or more embodiments include one or more of the following features. The radio access network is capable of providing a connection between the user endpoint and only one of the CS network and IMS core at a given time. The first pre-specified message includes a telephone number of the user endpoint and information about the voice service request. The second pre-specified message includes an IP address of the user endpoint and information about the data service request. The user endpoint includes a personal agent (PA), the PA including logic programmed to provide the combinational service to the user. The PA includes a combinational state machine. The PA includes logic configured to transmit a third pre-determined message to the SN regarding at least one of a combinational service the user attempts to invoke on the user endpoint and the network environment of the user endpoint. The IMS core communicates with the radio access network via a packet switched (PS) network. The data service includes a multimedia object. The SN includes logic configured to instruct the UE to render the multimedia object. The IMS core includes a home subscriber subsystem (HSS) in communication with the CSCF, wherein the HSS includes a profile of the user endpoint, and wherein the HSS includes logic configured to transmit the profile of the user endpoint to the CSCF. The profile of the user endpoint contains the SPT. The second pre-defined message includes a SIP invite.

### BRIEF DESCRIPTION OF THE DRAWINGS

In the Drawing,

FIG. 1 illustrates an overview of the service delivery platform and its connections to the circuit-switched and packet-switched networks.

FIG. 2 illustrates the logical components of the serving node component of the service delivery platform.

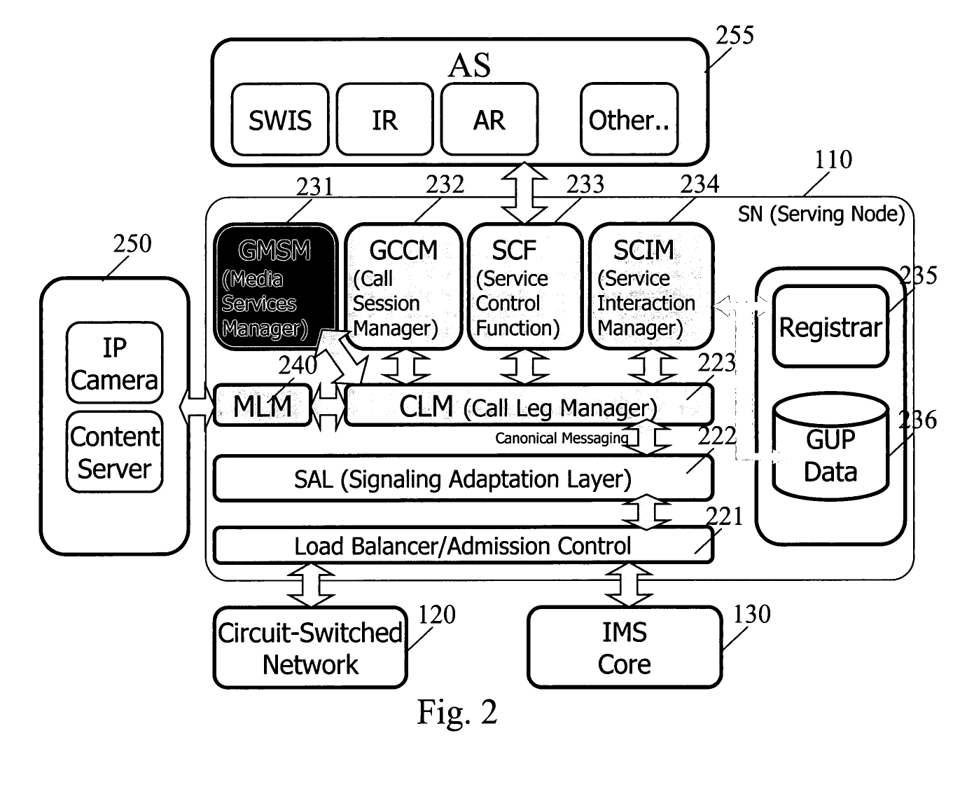

FIG. 3 illustrates the logical components of the personal agent component of the service delivery platform.

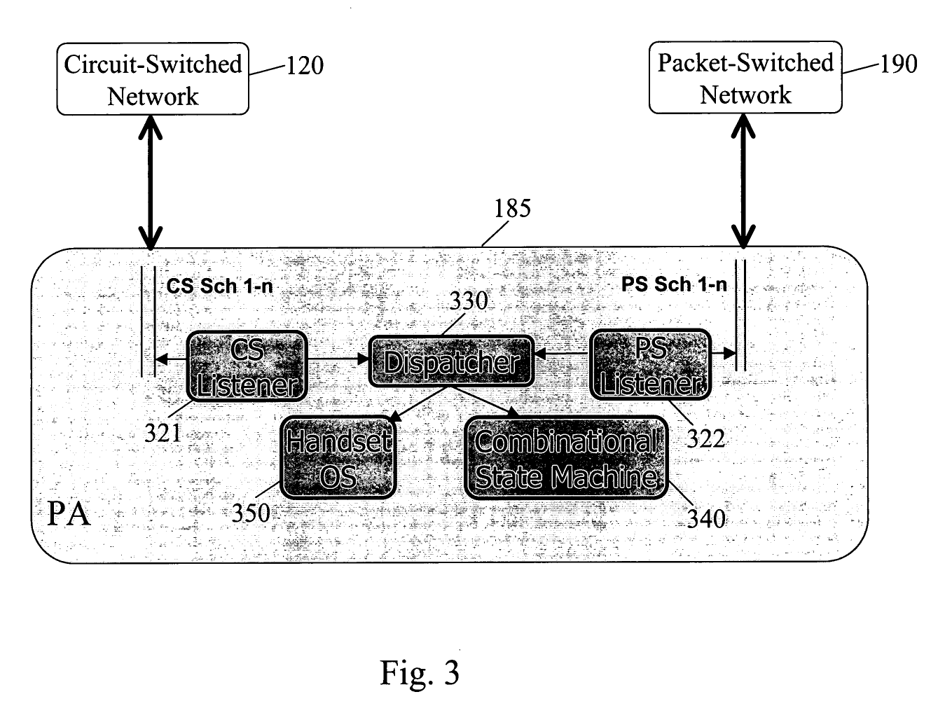

### DETAILED DESCRIPTION

The present invention provides systems and methods for enabling combinational services in wireless networks by using a service delivery platform, and without requiring deployment of a “3G” network.

Overview of Service Delivery Platform

The service delivery platform includes a Serving Node (SN) that supports combinational services by communicating with both the circuit-switched voice network and the packet-based IMS network. In particular, the SN is simultaneously aware of the states of the Service Control Function (SCF) services of a voice call between User Endpoints (UE), and of the registration states of UEs involved in a packet session. The service delivery platform also includes a Personal Agent (PA), which is a piece of service logic that resides in the UEs. The PA sends messages to the SN regarding services that the user would like to use, and also regarding its local network environment. The SN then responds appropriately by making appropriate voice network and/or IMS network services available to the user. Thus, the service delivery platform has one “eye” on the circuit-switched voice network and another “eye” on the IMS network, allowing it to deliver combinational services to users without needing to upgrade the existing network to 3G.

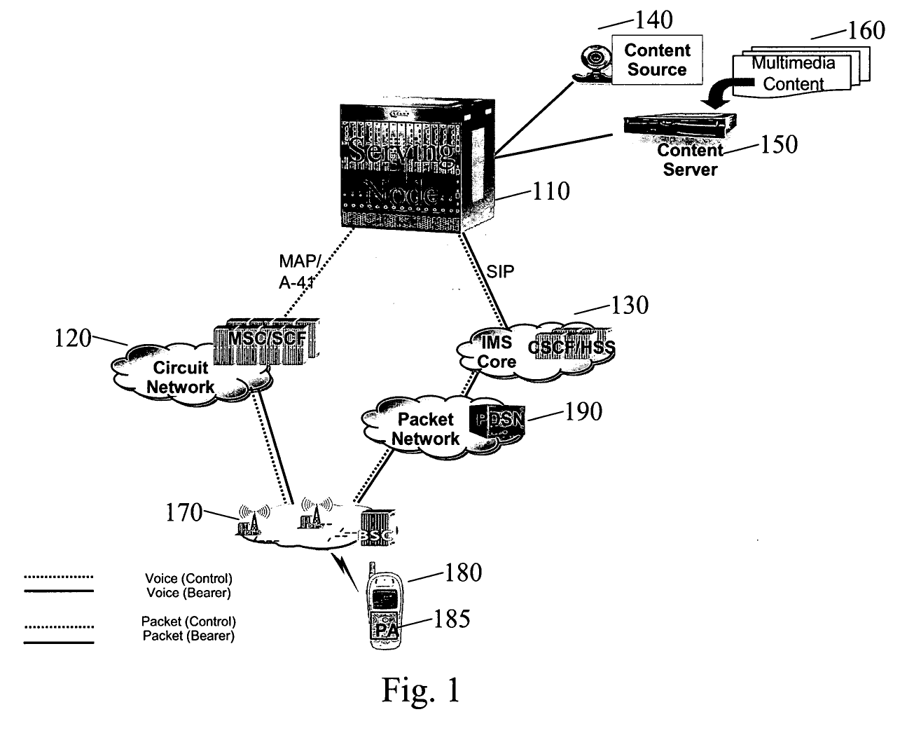

FIG. 1 is an overview of the service delivery platform and its connections to the circuit-switched and packet-switched networks. The service delivery platform includes SN 110 and PA 185, which resides on UE 180. As discussed in greater detail below, SN 110 and PA 185 communicate with each other via the existing circuit-switched and packet-switched network infrastructures in order to provide combinational services to the user.

The existing “2G” infrastructure includes radio access network 170, circuit-switched (CS) network 120, packet-switched (PS) network 190, and IMS core 130. As described above, CS network 120 includes Mobile Switching Center(s) (MSC) that provides wireless voice services to UE 180 over radio access network 170. PS network 190 includes Packet Data Serving Node(s) (PDSN) that act as the connection point between radio access network 170 and IMS core 130. IMS core 130 includes CSCF(s) and HSS(s) that provide multimedia services to UE 180 via PS network 190 and radio access network 170. However, as noted above, even if UE 180 is capable of processing signals from either network, i.e., can process a voice call or a multimedia session, radio access network 170 cannot support simultaneous connections between UE 180, CS network 120, and PS network 190. In other words, CS network 120, PS network 190, and radio access network 170 are not, by themselves, capable of providing combinational services to UE 180.

The service delivery platform provides combinational services to UE 180 as follows. SN 110 communicates both with CS network 120 and with IMS core 130, and appears like a normal system component to each of the two networks.

In CS network 120, normally when UE 180 requests a voice call or other service on CS network 120, the request triggers a Trigger Detection Point (TDP) at the MSC, and the MSC then sends a pre-specified message to a Service Control Function (SCF) that responds appropriately. The message includes, for example, the phone numbers of the calling and called parties, and the nature of the service request. However, in the service delivery platform, the MSC is programmed to provide the pre-specified message to SN 110 instead of to the SCF. Logic operating in SN 110 then processes the message, much as the SCF normally would, and returns a completion code to the MSC indicating that it may now proceed to process the voice call request. SN 110 thus learns information about services on the circuit-switched network that UE 180 invokes, e.g., the phone numbers of the calling and called parties, and the nature of the service, and also can authorize or even modify the service request when it returns the completion code to the MSC on CS network 120. Thus, SN 110 looks like an SCF to the MSC. SN 110 provides a control path to the CS network, but not a bearer path.

In the IMS core 130, the S-CSCF normally communicates with “third party” ASs in order to provide services to UE 180. Specifically, if an AS wants to communicate with UE 180, it sends a request to the S-CSCF which triggers a Service Point Trigger (SPT) in the S-CSCF. The SPT are analogous to the TDP of the MSC in the CS network 120, with some differences, as described in greater detail above. The SPT causes the S-CSCF to communicate appropriately with the UE 180. If UE 180 wants to communicate with an AS, i.e., to receive a service, it sends a SIP message to the S-CSCF, which triggers an SPT that instructs the S-CSCF to contact an AS to provide that service. In the described service delivery platform, SN 110 operates much like an AS, and indeed looks like an AS to the IMS core 130. When SN 110 wants to contact UE 180, it sends a transaction request to the S-CSCF, where it generates an SPT for the S-CSCF to forward the request to the UE. If UE 180 wants to contact the SN 110, it sends a SIP invite message to the S-CSCF, which generates an SPT for the S-CSCF to send the request to SN 110. The SN 110 then uses service logic to execute that request. Thus, in order to inter-work IMS 130 and SN 110, the S-CSCF simply needs to be configured to recognize the SN 110 as an AS. This allows SN 110 to learn about the packet-based connections that the UE and/or AS make with the S-CSCF. SN 110 provides both control and bearer connectivity to the IMS core 130 and external endpoints. Methods of interaction between SN 110 and the IMS core 130 are discussed in greater detail in U.S. patent application Ser. No. 11/283,038, the entire contents of which are incorporated herein by reference.

To readily communicate with CS network 120 and IMS core 130, SN 110 supports protocols for CS communications, e.g., SS7, and protocols for PS/IMS communications e.g., IP. For example, if SN 110 is exchanging a message with PA 185 in circuit-switched mode, it uses DTAP, and if SN is exchanging a message with PA 185 in packet-switched mode, it uses IP. The protocol the service delivery platform, i.e., SN 110 and PA 185, uses depends on which network is more appropriate for the message.

In general, the triggering mechanisms such as TDP and SPT are examples of mechanisms that can be used to transfer information from the CS network 120 and the IMS core 130 to SN 110; any mechanism that allows SN 110 to learn sufficient information about the UE's connections to the two networks can be used. One example is Unstructured Supplementary Services Data (USSD).

In addition to signaling traffic, SN 110 can also receive media traffic from content source(s) 140, e.g., camcorders or digital cameras, and content server(s) 150 that are capable of providing multimedia content 160. This functionality is described in greater detail below.

Serving Node Component of Service Delivery Platform

As described above, SN 110 communicates with CS network 120 and IMS core 130. Specifically, SN 110 includes Load Balancer/Admission Control 221, which includes a series of load balancing functions that handle incoming signals from CS network 120 and IMS core 130. Load Balancer/Admission Control 221 then passes the signals to Signaling Adaptation Layer (SAL) 222, which aggregates the signals into a common internal form.

Call Leg Manager (CLM) 223 then logically processes the aggregated signals. As will be readily apparent to skilled practitioners in the art, call models used to describe telephone connections often split call states in one or more “call legs.” In combinational services since both a voice call and a packet connection may exist contemporaneously the various call legs are integrated into a single logical session by another function called the General Call Session Manager (GCCM) 232. Control of call legs is discussed in greater detail in U.S. patent application Ser. No. 11/283,038, the entire contents of which are incorporated herein by reference.

In addition to signaling traffic, SN 110 can also receive media traffic from content servers 250, such as camcorders, external cameras, or proxies for same. A logical function called the Media Leg Manager (MLM) 240 handles this media traffic, using protocols such as RTP, IP, and/or RTSP. Media traffic may also be re-directed by SN 110 under roaming scenarios, as described in greater detail in U.S. patent application Ser. No. 11/370,594, the entire contents of which are incorporated herein by reference. Various media servers and content servers will be not necessarily be aware of SN 110; rather, SN 110 may act as a proxy and retrieve content and media from such servers, then process it and transmit it to mobile handsets. In order to carry out these functions, SN 110 supports various proxy functions.

SN 110 supports a variety of combinational services, some examples of which are described below, and also provides an interface for supporting 3^{rd} party Application Servers (AS) 255. These services, as stated earlier, generally involve contemporaneous circuit-switched and packet-switched connections. Some examples of such services as “See What I See” (SWIS), “ImageRing” (IR), and “AdRing” (AR) are described in greater detail below. The architecture of SN 110 includes SCF 233 and Registrar 235 components cooperatively to make such services possible. In those cases where an external media service is needed, the proxy components of SN 110 may be used to receive the external media, process it internally for use in mobile handsets, and then transmit the media to the handsets. Under roaming situations, SN may also use its mobility management components as described in greater detail in U.S. patent application Ser. No. 11/370,594, the entire contents of which are incorporated herein by reference, to ensure that a favorable network connection is used to deliver the media to the roaming mobile handset. In particular, services from the circuit-switched and packet-switched networks may be combined in various temporal sequences and modalities. SN 110 contains a Service Control Interaction Manager (SCIM) 234 component that uses policy driven service logic to resolve feature interactions when services are combined from different or the same networks are combined in various ways.

Personal Agent Component of the Service Delivery Platform

A special piece of service logic installed in a user's handset is referred to as the Personal Agent (PA). The basic architecture of PA 185 assumes that the handset supports connections to both the circuit-switched (CS) network 120 and the packet-switched (PS) network 190, which are described in greater detail above. Generally, some handsets simultaneously support connections to both networks, and other handsets support a connection to only one network at a time. Here, the handset is assumed to support a number of CS signaling channels (CS Sch 1-n), and also a number of PS signaling channels (PS Sch 1-n). Thus, when a network entity such as SN 110 sends a message to PA 185 via CS network 120 or PS network 190, the message arrives at the corresponding signaling channel (CS Sch 1-n or PS Sch 1-n).

The PA includes CS “Listener” 321 and PS “Listener” 322, which receive messages on the signaling channels (CS Sch 1-n) and (PS Sch 1-n), respectively. CS Listener 321 and PS Listener 322 direct these messages to another service logic component called the “Dispatcher” 330. Dispatcher 330 uses internal logic to direct the messages appropriately either to the handset's operating system (OS) 350 or to the Combinational State Machine 340. Combinational State Machine 340 handles the message according to its service logic. The actions of the combinational state machine are specific to the service that is being implemented. For example, if the service were “ImageRing,” described in more detail below, and the incoming message was a call alert, then the state machine would specify actions that would render an image on the display including a Caller ID indication and simultaneous ringing of the phone.

As an illustrative example, consider a combinational service in which party A wishes to transmit a picture to party B while making a circuit-switched switched voice call to party B. Further assume that the underlying wireless network does not support multiple radio access bearers (RABs). Thus, both handsets already share a CS connection, and not a PS connection. In such a case, the PA in the handset of party A sends a message e.g., using a USSD message, to the PA in the handset of party B via CS network 120 and SN 110. The message includes instructions to end the CS voice call; initiate a PS connection to receive the picture; and to end the PS connection.

The appropriate Listener in party B's handset receives the message and transmits it to the Dispatcher, which then sends it to the Combinational State Machine. The Combinational State Machine in party B's handset then interprets the message, terminates the CS voice call, initiates a PS connection to receive the picture and, after receiving the picture, terminates the PS connection. Then, the Combinational State Machine in party A's handset initiates a new CS voice call to party B's handset, and the parties can continue talking.

Some other illustrative examples of combinational services that the service delivery platform provides will now be described.

### EXAMPLE 1

Switching from Voice Call to Combinational Service, e.g., “See What I See”

As an illustrative example, consider a case where party A is in a voice call with party B over a circuit-switched network that has not been upgraded to 3G, as is typical for voice calls today. During the voice call, party A decides to use his handset-integrated camera to show an object to party B, or decides to share a video file stored in the handset with party B. In other words, party A wants to upgrade his voice call with party B to a combinational service.

Party A signals his intention to start the combinational service by invoking an appropriate application on the handset, and he expects the service to be available shortly thereafter. Party A and party B then share the photo or video and converse. At the end of this interaction, the parties hang up. It is assumed that charging authorizing, lawful intercept, and all such service control functions are performed and available on the combinational voice and data sharing service.

Continuing with this illustrative example, we examine the use case from the network point of view. Since the radio network is not a 3G network, it does not inherently support two simultaneous wireless network connections, or Radio Access Bearers (RABs). Therefore, once party A establishes his voice call with party B, the radio network cannot simultaneously provide a multimedia session between parties A and B. Recall also that the example above does not require party A to hang up the circuit-switched voice call and then initiate a new call for combinational services to party B.

Instead, when party A indicates that he wants to upgrade the voice call to a combinational service by invoking the appropriate application on his handset, the PA in party A's handset intercepts the application invocation request and sends a trigger message to the serving node (SN). DTAP is one example of a protocol the PA can use to send the message. The trigger message activates a Trigger Detection Point (TDP) in the SN, which makes the SN aware that party A wants to start a combinational service. The SN and PA then execute the following steps in order to provide the combinational service to parties A and B:

1. Retrieve the calling and called party information for party A and B stored previously from the TDP interactions.

2. Terminate the circuit-switched call between party A and B, e.g., in response to the trigger message the PA sends to the SN.

3. The PA service logic on party A's handset confirms that it can make a packet connection to the packet switched network, e.g., IMS, as does the PA service logic on party B's handset.

4. Initiate a VoIP/SIP call between party A and party B using a “third party call control” mechanism, e.g., a back-to-back user agent (B2BUA), as is used in IMS networks.

5. The PA logic in party A's handset accepts the VoIP/SIP call, and displays a “ready to initiate combinational call” to party A. The PA logic also keeps the handset from “ringing” when the VoIP/SIP call is established. The PA logic in party B's handset performs a similar function.

6. PA logic in party A's handset adds a multimedia stream to the VoIP/SIP connection, and PA logic in party B's handset receives the multimedia stream. In the case of a photo, the handset takes only a short time to transmit the multimedia stream, and in the case of a video, the handset transmits a continual multimedia stream.

7. PA logic in the handsets displays “proceed with service” to parties A and B. Parties A and B can then converse and view the multimedia object, e.g., the photo or video.

8. At the end of the combinational service, the PA logic in the handsets of parties A and B follows normal procedures for terminating the VoIP/SIP call.

In summary, the PA and SN replace the original circuit-switched voice connection with a packet-switched connection that can support multiple media streams. Since VoIP/SIP connections support multiple media streams simultaneously, there is no need for the radio access network to support multiple RABs. Also, because the PA and SN used cached information about parties A and B to replace the connection, there is no need for either party to re-dial phone numbers in order to create a combinational connection. This provides a seamless call experience for the two parties.

### EXAMPLE 2

Accessing Data Services with a Telephony Interface, e.g., “Dial a Camera”

Normally, in order to initiate a voice call, a user uses the familiar telephony interface, i.e., to “dial” a phone number. Or, in order to initiate a data service, e.g., web browsing, the user initiates a PC-style application on the handset by executing service logic (“client code”) that resides on the handset. However, handsets are much more easily (and more frequently) used for voice calls than for data services. For example, handsets typically have only a numeric keypad, which lacks ready access to characters that are useful for data services, such as the period, the colon, and “Ε.” Users have also typically used telephony services for considerably longer than they have used data services, and therefore they are much more familiar with the telephony interface than with PC-style applications.

However, as illustrated below, the service delivery platform creates a telephony interface that can be used to invoke data services, in other words “connecting” the separate voice and data networks. Consider a user who wants to use his handset to connect to his own digital camera, which is on the IP network. In a typical data services network, to do this the user would have to know and to type the camera's IP address into his handset, both of which would be cumbersome. Instead, in the described embodiment, the camera has an assigned telephone number that the user learns, e.g., by an advertisement. The service delivery platform gives the user access to the camera as follows.

1. The user uses his handset to dial the camera's telephone number. The handset can also have a special button that automatically dials the number of the camera, when pressed.

2. The circuit-based network's MSC receives the dialed digits as part of a “call origination” event, which generates an appropriate TDP.

3. The TDP causes the MSC to send a pre-specified message to the SN.

4. SCF logic residing in the SN authenticates the handset using caller-ID and/or the PA software residing on the handset.

5. The SCF logic processes the message and thus ascertains that this “call” is intended to access the camera, i.e., the SCF logic resolves the dialed phone number to the camera's IP address.

6. The SN instructs the MSC to deny the “call origination” request.

7. The SN, using the IMS network, initiates a connection with the PA service logic on the user's handset, which originated the call request.

8. The SN instructs the PA service logic to launch the “camera” application on the handset.

9. The SN establishes a connection between the camera source and the PA service logic, so the camera becomes accessible to the user via the camera application on his handset.

The telephony interface can be similarly used to establish appropriate connections between the handset and any element on the IP network, not just a user's own digital camera. In some cases, the SN logic will need to support a “proxy” functionality that allows the inter-connection between the IP service source and the PA to be seamless.

Some users may have more than one networked camera (or other appropriate device), or may wish to access other users' cameras (or other appropriate devices). The service delivery platform provides a straightforward way of allowing the user to select one of the plurality of devices, without needing to know a different telephone number for each device, that is similar to that described above. In this case, however, the phone number the user dials is associated with more than one camera. The SCF logic residing in the SN determines that this “call” is intended to access one of a plurality of cameras associated with the number, and instructs the PA on the user's handset to display a menu of cameras associated with the number. If the user selects someone else's camera, the SCF can ask for a “pin-code” or other authentication mechanism to authorize the user to access the camera.

### EXAMPLE 3

Synchronizing Packet-Switched and Circuit-Switched Connections, e.g., ImageRing/AdRing

Because the service delivery platform has knowledge of both the CS and PS networks, the platform could be said to be aware of the circuit and packet components of combinational services. Specifically, the SN and the PA can be used together to synchronize a packet-switched connection with a circuit-switched connection in the user's handset, even if the handset itself cannot simultaneously support both kinds of connections.

For example, if party A calls party B, the service delivery platform can precede the circuit-switched voice call with a packet-switched data connection. The service delivery platform can play an announcement or display a picture on party B's handset before presenting a “voice call indication” that alerts party B that party A is attempting to call him. In such a case, the PA in party B's handset receives the announcement or picture via the PS network, and holds the announcement or picture until it also receives the “voice call indication” via the CS network. Then, the PA in party B's handset synchronizes the rendering of the announcement or picture with the alert that party A is attempting to call. This can be done, e.g., with the following sequence of steps:

1. Party A dials the telephone number of party B.

2. The PA on party A's handset captures and holds the dialed digits.

3. The PA on party A's handset initiates and establishes a packet connection to party B's handset via SN.

4. The PA on party A's handset transmits a multimedia object, e.g., an announcement or picture, to the PA on party B's handset.

5. The PA on party B's handset receives and holds the multimedia object.

6. The PA on party A's handset initiates a circuit-switched voice call to party B's handset.

7. The PA on party B's handset receives a voice call indication.

8. The PA on party B's handset synchronizes the display/presentation of the multimedia object with the alert that party B is receiving a voice call from party A.

It should be observed that step (2) above introduces a delay in the overall process, so that after party A dials party B's phone number, party A will have to wait for the service delivery platform to establish the packet connection and to deliver the multimedia object before establishing the voice call. This delay may be circumvented, however. For example, the announcement can be kept in the SN instead of in the users' handsets. Alternately, the procedure above can be modified as follows:

1. Party A dials the telephone number of party B.

2. The circuit voice call request is fielded by the MSC as per standard voice call flow procedures.

3. The voice call request triggers a TDP in the MSC, causing the MSC to send a pre-determined message, containing the calling and called numbers, to the SN.

4. SN receives the pre-determined message from the MSC, holds the return response to the MSC, and establishes a packet connection with party B's handset.

5. SN transmits a multimedia object to the PA on party B's handset.

6. The PA on party B's handset receives and holds the multimedia object.

7. SN responds back to MSC “proceed with voice call.”

8. The PA on party B's handset receives the circuit voice call indication.

9. The PA on party B's handset synchronizes the display/presentation of the multimedia object with the alert that party B is receiving a voice call from party A.

It should be noted that some of the incorporated patent references, e.g., U.S. Provisional Patent Appln. No. 60/775,112, introduced the idea of sequentially alternating the circuit and packet components in a combinational service, potentially many times. However, in some of the embodiments described herein, the packet connection is used exactly once.

As a further extension, a third party can use the packet connection to send a multimedia object to the calling and/or called parties. For example, consider a case where party C (hereafter referred to as “advertiser”) wishes to “sponsor” or “subsidize” a telephone call between parties A and B. In order to make parties A and B aware of this facility, the advertiser can send an indication to all of the handsets that are included in his advertising campaign. Upon receiving the indication, party A or party B initiates the call. One example of a procedure to effectuate this process is as follows:

1. Advertiser requests the SN to send a “sponsored call indication” to handsets participating in the campaign. The SN can identify participating handsets with an out-of-band process which asks users to “opt-in” to the campaign (or a group of campaigns), and identifies participating handsets when they register during power-on. Party A and party B are part of the campaign.

2. SN sends the “sponsored call indication” to participating handsets using the underlying packet network.

3. Subsequently, party A dials the telephone number of party B.

4. The MSC fields the circuit voice call request as per standard voice call flow procedures.

5. The voice call request triggers a TDP in the MSC, causing the MSC to send a pre-determined message, containing the calling and called numbers, to the SN.

6. SN receives the pre-determined message, holds the return response to the MSC, and establishes a packet connection with party B.

7. SN transmits the multimedia object specified by the advertiser to party B via the packet connection.

8. The PA in party B's handset receives and holds the multimedia object.

9. SN responds back to MSC “proceed with voice call.”

10. The PA in party B's handset receives a circuit voice call indication.

11. The PA in party B's handset synchronizes the multimedia object from the advertiser with “voice call indication” from party A and renders both on part B's handset.

The above procedure can be further streamlined and the time delay reduced by sending a priori the multimedia object, or a group of objects, to participating handsets, which then store the object(s). Then, the SN needs only to send the identifying tag of the stored object to the handset during the call. Objects that are sent a priori to participating handsets correspond to “ongoing campaigns” from advertisers, and may be refreshed as the requirements and durations of campaigns change over time.

In another example, the third party sends the multimedia object to the handset of the calling party, but not of the called party, after the current call is terminated. The handset renders the object for a subsequent (possibly, next) incoming call to the original calling party. This can be done as follows:

1. Part A dials the telephone number of party B.

2. The MSC fields the circuit voice call as per standard call flow procedures.

3. The voice call request triggers a TDP in the MSC, causing the MSC to send a pre-determined message, containing the calling and called numbers, to the SN.

4. SN receives the pre-determined message, stores the information in it, and responds back to MSC “proceed with voice call.”

5. MSC connects call between parties A and B as per standard call flow procedures.

6. Call is established between parties A and B; parties talk and subsequently terminate call.

7. The call termination triggers a TDP in the MSC, causing the MSC to send a message to SN that the call has been terminated.

8. SN receives the message.

9. SN transmits a multimedia object to party A's handset.

10. The PA in party A's handset receives the multimedia object and stores it in the handset's memory.

11. For a subsequent incoming call to party A (including but not limited to the next call party A receives after receiving the multimedia object), the PA in party A's handset intercepts the incoming call indication and synchronizes the rendering of the multimedia object with the incoming voice call indication.

It should be further observed that steps 7-8 of the above example are optional; in particular, the MSC need not inform the SN of call termination. Rather, the SN may introduce a delay in its service logic and then attempt to transmit the multimedia object to party A, and repeat the attempt at periodic intervals until successful. In radio access networks such as UMTS, which support multiple radio access bearers, the multimedia object can be sent to a user in parallel with an ongoing circuit-switched voice cal. It will be appreciated the multimedia object can be sent to only the calling party, to only the called party, or to both.

### Incorporated Patent Reference

Embodiments of the present invention build on techniques, systems and methods disclosed in earlier filed applications, referred to herein as the “incorporated patent references,”including but not limited to:

U.S. Provisional Patent Application No. (TBA), filed May 16, 2006, entitled System and Method for Supporting Combinational Services Without Simultaneous Packet and Circuit Connections;

U.S. patent application Ser. No. 11/166,470, filed Jun. 24, 2005, entitled System and Method to Provide Dynamic Call Models for Users in an IMS Network;

U.S. patent application Ser. No. 11/166,407, filed Jun. 24, 2005, entitled Method and System for Provisioning IMS Networks with Virtual Service Organizations Having Distinct Service Logic;

U.S. patent application Ser. No. 11/166,456, filed Jun. 24, 2005, entitled Method of Avoiding or Minimizing Cost of Stateful Connections Between Application Servers and S-CSCF Nodes in an IMS Network with Multiple Domains;

U.S. patent application Ser. No. 11/166,406, filed Jun. 24, 2005, entitled Mediation System and Methodfor Hybrid Network Including an IMS Network;

U.S. patent application Ser. No. 11/370,594, filed Mar. 8, 2006, entitled Associated Devised Discovery in IMS Networks;

U.S. patent application Ser. No. 11/282,924, filed Nov. 18, 2005, entitled IMS Networks with A VS Sessions with Multiple Access Networks;

U.S. Provisional Patent Application No. 60/735,112, filed Nov. 9, 2005, entitled System and Method to Allow Interruption of Unicast Data Service Utilizing a Class B Handset or a Dual Mode Handset (DMH) to Inform it of a Circuit-Based Incoming call, so the Handset Can Accept the Call if the User Desires;

U.S. patent application Ser. No. 11/283,038, filed Nov. 18, 2005, entitled System and Method of Interworking Non-IMS and IMS Networks to Create New Services Utilizing Both Networks;

U.S. patent application Ser. No. 11/283,042, filed Nov. 18, 2005, entitled System and Method to Mediate Delivery of Legacy, Non-IMS Services into an IMS Network;

U.S. patent application Ser. No. 11/370,793, filed Mar. 8, 2006, entitled Digital Home Networks Having a Control Point Located on a Wide Area Network;

U.S. Provisional Patent Application No. 60/776,137, filed Feb. 23, 2006, entitled Enabling Combinational Services in Networks that Do Not Support Multiple Radio Access Bearers; and

U.S. Provisional Patent Application No. 60/779,954, filed Mar. 7, 2006, entitled Using Telephony Interface for Invoking Data Services in Wireless Communication Networks;

the contents of which are hereby incorporated by reference in its entirety. The present techniques, however, are not limited to systems and methods disclosed in the incorporated patent applications. Thus, while reference to such systems and applications may be helpful, it is not believed necessary to understand the present embodiments or inventions.

Other embodiments are within the following claims.

What is claimed is:

1. A method of providing combinational services to a user endpoint, the method comprising:
providing a radio access network in communication with the user endpoint;
providing a circuit-switched (CS) network in communication with the radio access network, the CS network comprising at least one mobile switching center (MSC) capable of providing a voice service to the user endpoint via the radio access network;
providing an IP multimedia subsystem (IMS) core in communication with the radio access network, the IMS core comprising at least one call state control function (CSCF);
providing one or more application servers (AS) in communication with the IMS core, the one or more AS capable of providing a corresponding one or more data services to the user endpoint via the CSCF and radio access network;
providing a serving node (SN) in communication with the CS network and the IMS core;
configuring logic in the MSC to send a first pre-defined message to the SN in response to a trigger detection point (TDP) that is triggered by the user endpoint requesting a voice service or a first entity requesting a voice service with the user endpoint;
configuring logic in the CSCF to send a second pre-defined message to the SN in response to a service point trigger (SPT) that is triggered by the user endpoint requesting a data service or by a second entity requesting a data service with the user endpoint; and
configuring logic in the SN to receive and respond to at least one of the first and second pre-defined messages by at least one of sending instructions to the MSC to provide a voice service to the user endpoint and sending instructions to the AS to provide a data service to the user endpoint.

2. The method of claim 1, wherein the radio access network provides a connection between the user endpoint and only one of the CS network and IMS core at a given time.

3. The method of claim 1, further comprising registering the user endpoint to the IMS core.

4. The method of claim 3, wherein registering the user endpoint to the IMS core comprises obtaining at the CSCF information about the profile of the user endpoint.

5. The method of claim 1, wherein the profile of the user endpoint comprises the SPT.

6. The method of claim 1, wherein the SN determines whether the combinational service is authorized before responding to at least one of the first and second pre-specified messages.

7. The method of claim 1, wherein the first pre-defined message comprises a telephone number of the user endpoint and the nature of the voice service request.

8. The method of claim 1, wherein the second pre-defined message comprises an IP address of the user endpoint and the nature of the data service request.

9. A system for providing combinational services to a user endpoint, the system comprising:
a radio access network in communication with the user endpoint;
a circuit switched (CS) network in communication with the radio access network, the CS network comprising at least one mobile switching center (MSC) capable of providing a voice service to the user endpoint via the radio access network;
an IP multimedia subsystem (IMS) core in communication with the radio access network, the IMS core comprising at least one call state control function (CSCF);
an application server (AS) in communication with the IMS core, the AS capable of providing a data service to the user endpoint via the IMS core and the radio access network;
a serving node (SN) in communication with the CS network and the IMS core,
wherein the at least one MSC comprises logic configured to provide a first pre-determined message to the SN in response to a trigger detection point (TDP) that is triggered by voice service request by the user endpoint or by a first entity attempting to initiate a voice service with the user endpoint;
wherein the at least one CSCF comprises logic configured to provide a second pre-determined message to the SN in response to a service point trigger (SPT) that is triggered by a data service request by the user endpoint or by a second entity attempting to initiate a data service with the user endpoint; and
wherein the SN comprises logic configured to initiate a combinational service in response to receiving at least one of the first and second pre-determined messages, wherein initiating a combinational service comprises at least one of providing instructions to the MSC to initiate a voice service to the user endpoint and providing instructions to the AS to initiate a data service to the user endpoint.

10. The system of claim 9, wherein the radio access network is capable of providing a connection between the user endpoint and only one of the CS network and IMS core at a given time.

11. The system of claim 9, wherein the first pre-specified message comprises a telephone number of the user endpoint and information about the voice service request.

12. The system of claim 9, wherein the second pre-specified message comprises an IP address of the user endpoint and information about the data service request.

13. The system of claim 9, wherein the user endpoint comprises a personal agent (PA), the PA comprising logic programmed to provide the combinational service to the user.

14. The system of claim 13, wherein the PA further comprises a combinational state machine.

15. The system of claim 13, wherein the PA further comprises logic configured to transmit a third pre-determined message to the SN regarding at least one of a combinational service the user attempts to invoke on the user endpoint and the network environment of the user endpoint.

16. The system of claim 9, wherein the IMS core communicates with the radio access network via a packet switched (PS) network.

17. The system of claim 9, wherein the data service comprises a multimedia object.

18. The system of claim 17, wherein the SN further comprises logic configured to instruct the UE to render the multimedia object.

19. The system of claim 9, wherein the IMS core further comprises home subscriber subsystem (HSS) in communication with the CSCF, wherein the HSS comprises a profile of the user endpoint, and wherein the HSS comprises logic configured to transmit the profile of the user endpoint to the CSCF.

20. The system of claim 19, wherein the profile of the user endpoint contains the SPT.

21. The system of claim 9, wherein the second pre-defined message comprises a SIP invite.
